(19) United States
(12) Patent Application Publication
(10) Pub. No.: US 2025/0078579 A1
(43) Pub. Date: Mar. 6, 2025

(54) SYSTEM AND METHOD FOR AUTOMATIC PAYMENT

(71) Applicant: HAREX INFOTECH INC., Seoul (KR)

(72) Inventor: Kyung Yang PARK, Seoul (KR)

(73) Assignee: HAREX INFOTECH INC., Seoul (KR)

(21) Appl. No.: 18/726,673

(22) PCT Filed: Dec. 13, 2022
(86) PCT No.: PCT/KR2022/020230

§ 371 Date: Jul. 3, 2024

(30) Foreign Application Priority Data
Jan. 3, 2022 (KR) 1020220000495
Nov. 14, 2022 (KR) 1020220151708

(51) Int. Cl. G07B 15/02; G06Q 20/40; G06Q 50/40; G06V 20/62

(52) U.S. Cl. CPC G07B 15/02; G06Q 50/40; G06Q 20/40145; G06V 20/625

(57) ABSTRACT

An automatic payment system and method using the automatic payment system are disclosed. The automatic payment system and the method make user identification means to become an ID and register the same using an algorithm (for example, a user can be identified using biometric information including face, other behavioral patterns, or the like, or a user can be identified using license plate information of a vehicle registered by the user), and perform an automatic payment process for the provision of goods/services while connecting the user application. The automatic payment method includes (a) performing a user application connection process while registering user information, (b) generating payment information while recognizing a user, and (c) performing user application connection and automatic payment approval.

### BACKGROUND

### 1. Technical Field

The present disclosure relates to an automatic payment system and method, and more particularly, to an automatic payment system and method which make user identification means to become an ID and register the same using an algorithm (for example, a user can be identified using biometric information including a face, other behavioral patterns, or the like, or a user can be identified using license plate information of a vehicle registered by the user), and perform an automatic payment process for the provision of goods/services while connecting a user application.

### 2. Related Art

According to the related art, a user performs payment by delivering his/her credit card, smartphone, or the like to a store clerk, and taking back the credit card or smartphone from the store clerk after the completion of the payment. So, the untact payment services are not provided, and thus there are concerns in terms of mutual hygiene management, and when a third party acquires a credit card without the permission, it may lead to a problem in that payment would be made illegally.

### DETAILED DESCRIPTION

### Problems to Solve

The present disclosure has been proposed to solve the aforementioned problems, and an object of the present disclosure is to provide an automatic payment system and method which provide a convenient and fast payment service by being automatically connected to the application installed on the user's portable terminal and performing the automatic payment process using the pre-registered user's payment method, at the same time as recognizing the user (Example: processes such as recognizing a user's face or recognizing the license plate of a registered vehicle matched to a user).

### Solutions to Solve the Problems

An automatic payment method according to the present disclosure includes (a) performing a user application connection process while registering user information, (b) generating payment information while recognizing a user, and (c) performing user application connection and automatic payment approval.

The step (a) is registering the user information including user ID information generated by applying a personal identification algorithm to biometric information.

The step (a) is automatically generating and registering an additional image in consideration of at least one of whether an accessory is worn or not and a photographing angle, when face image information is included in the biometric information.

The step (b) is generating the payment information for grouped users, and the step (c) is performing the automatic payment approval using the payment method of at least one of the grouped users.

The step (b) is generating the payment information for a payment amount set for each user classification and determining the payment information in consideration of a user's basic information, or generating a payment target amount for goods or services selected by the user as the payment information.

An automatic payment server according to the present disclosure includes an input unit which receives a user recognition information and a payment amount information, a memory in which an automatic payment program is stored, and a processor which performs the automatic payment program, wherein when user recognition information matched to the user identification information which has been made to become an ID by the algorithm is received, the processor performs an automatic payment approval process using a pre-registered payment method based on the payment amount information.

When the processor uses one of a plurality of payment methods pre-registered by a user, the processor automatically selects a payment method in consideration of user benefits including discounts or accumulations according to classification of affiliated stores, and performs a payment approval process.

According to the present disclosure, a user's portable terminal device using an automatic payment service includes an input unit which receives payment information according to a user recognition result, a memory in which an automatic payment program is stored, and a processor which performs the automatic payment program, wherein the processor transmits an approval request for the payment information to a financial institution to perform a user-centric payment.

The processor of the user's portable terminal device transmits an approval request for the payment information when receiving a confirmation input for an affiliated store information and a transaction amount information for which user recognition has been performed.

The processor of the user's portable terminal device selects a payment method matched to the corresponding payment from among a plurality of pre-registered payment methods, in consideration of an affiliated store information included in a payment information received according to the user recognition result and a shared benefit information, and automatically transmits the approval request using the selected payment method.

### Advantageous Effects

According to the present disclosure, there is an effect of providing a convenient and fast payment service by recognizing a user (Example: a user at the entrance of a subway ticket gate, a user getting on a bus, a user requesting payment at an affiliated store such as a chicken restaurant, and a user whose vehicle exits a parking lot) requesting the provision of goods/services and performing the automatic payment in connection with the user application installed on the user's portable terminal.

The effects of the present disclosure are not limited to those mentioned above, and other effects not mentioned will be clearly understood by those skilled in the art from the description below.

### BRIEF DESCRIPTION OF THE DRAWINGS

FIG. 1 shows an automatic payment method according to an embodiment of the present disclosure.

FIG. 2 shows an automatic parking fee payment system according to an embodiment of the present disclosure.

FIG. 3 shows a vehicle registration process according to an embodiment of the present disclosure.

FIG. 4 shows an automatic payment setting process according to an embodiment of the present disclosure.

FIG. 5 shows an automatic parking fee payment process according to an embodiment of the present disclosure.

FIG. 6 shows a progress process performed when the automatic parking fee payment fails, according to an embodiment of the present disclosure.

FIG. 7 is a block diagram representing a computer system for implementing a method according to an embodiment of the present disclosure.

### DETAILED DESCRIPTION

The above-described objects and other objects, and advantages and characteristics of the disclosure, and methods of achieving them will become apparent with reference to the embodiments described below in detail in conjunction with the accompanying drawings.

However, the present disclosure is not limited to the embodiments disclosed below, but will be implemented in a variety of different forms, and the following embodiments are merely provided to easily inform those skilled in the art of the purpose, configuration and effects of the disclosure, and the scope of the patent right of the present disclosure is defined by the description of the claims.

Meanwhile, as used herein, the terms are for the purpose of describing the embodiments, and are not intended to limit the present disclosure. Herein, terms in the singular form also relate to the plural form unless specifically stated otherwise in the context. As used herein, the “comprises” term(s) and/or “comprising” specify/specifies the presence of stated components, steps, operations, and/or elements, but do/does not preclude the presence or addition of at least one other component, step, operation, and/or element.

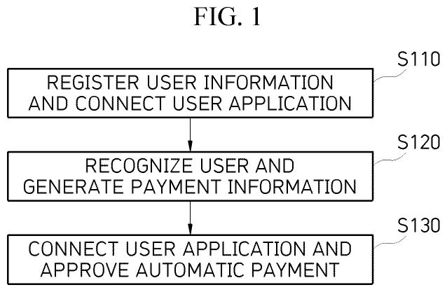

FIG. 1 shows an automatic payment method according to an embodiment of the present disclosure.

An automatic payment method according to an embodiment of the present disclosure includes performing a user application connection process while registering user information (S110), generating payment information while recognizing the user (S120), and performing automatic payment approval while performing user application connection (S130).

In step S110, a personal identification algorithm is applied using biometric information including at least one of a face image and a behavior pattern, and the user ID information generated through this (defined as identification information which is discerned as automatic payment progress request information for the provided service) is connected with the application. In this regard, when registering the user's face image, it is possible to automatically generate and register an image of the face when wearing a hat, an image of the face when wearing/removing eyeglasses, an image of the face with the hair tied or untied, images (additional images) of the main face region recognized by photographing angle (when looking from the front, when looking up with a camera placed below, when looking down with a camera placed above), and the like, in addition to the general image (image of the face when looking straight ahead and not wearing accessories, such as an identification photo).

Additionally, in step S110, the user information is registered, including identification target object information (e.g., vehicle license plate information that the user wants to register), and the user application connection process is performed.

In step S120, the user requesting the provision of goods or services is recognized, and the payment information is generated. For example, a process of recognizing the face of a user passing through a subway ticket gate, recognizing the face of a user getting on a bus, or recognizing the face of a user wishing to make a purchase at an affiliated store (e.g., convenience store, fried chicken restaurant, etc.), or recognizing the number of the vehicle that a user are going to get on to leave the parking lot is performed, and the payment information is generated.

The payment information is generated based on subway fares, bus fares, prices of items that the user wants to purchase at affiliated stores, and parking fees calculated according to parking time.

Also, the payment information can be generated for each grouped user. For example, it is assumed that one adult passes through a subway ticket gate together with one preschool child. The one adult takes face images of himself and the one preschool child accompanying him using an application installed on his portable terminal, and registers the face images to the server. When the one adult passes through the subway ticket gate while subjecting his/her face to being recognized by the camera, and then subjecting the face of the one preschool child accompanying him/her to being recognized by the camera, the payment information including the sum of subway fares for the one adult and the one preschool child is generated through the payment method of the one adult (S120), and the user application connection and automatic payment approval process is performed (S130). Payment for the entire usage amount of the group may be performed using the payment method of the representative (the aforementioned one adult) among the grouped users, or distributed payment for the entire usage amount of the group may be performed through a Dutch pay means for the grouped users.

Alternatively, an automatic payment approval may be performed using a payment method of another user (payment representative) in a remote location that is matched to the recognized and grouped user. For example, if one adult registers two minor children as users of his/her payment methods, and the faces of the two minor children are recognized in the process of using goods or services in a theme park, it is possible to perform automatic payment approval using the payment method of the one adult (payment representative).

Additionally, the payment information may be generated differently for each user based on the user's personal information or according to the user's use time point. For example, it is assumed that a performance hall operated by a local government provides a 50% discount to users at an age of 65 or more. In a case where the user's personal information (date of birth) is registered/managed together with the recognition information (face image), and it is automatically connected to the user's application according to the face recognition from the time when the user turns 65 years of age or older, the payment information for the amount reduced by 50% from the conventional amount is generated (S120), and the user application connection and automatic payment approval process is performed (S130).

When a specific menu or several items is/are selected at an affiliated store, the total amount is generated as the payment amount information, and as the user's face is recognized, an automatic payment process for the payment amount information according to the total amount is performed (S120 and S130). At this time, when recognizing the user's face, a genuine or false identification procedure may be performed to determine whether the user's face is that of a real person.

Additionally, it is possible to determine whether or not to proceed with payment by comparing the location of the portable terminal possessed by the user with the location of the affiliated store. For example, in the case of twin users who cannot be distinguished by feature point analysis, each user allows the location information of his/her portable terminal to be shared, and if the location information corresponds to the location of the affiliated store, the automatic payment process is performed through the face recognition, or the automatic payment process is performed using means such as recognizing the location of the portable terminal based on RSSI, or recognizing the location of the portable terminal by photographing a code provided in the affiliate store using the portable terminal. In another example, when a user leaves his/her portable terminal at home and requests the automatic payment through the user face recognition at an affiliated store located near the company that is at a certain distance away from home, it is possible to confirm the user's true intention for the payment request through additional information means (e.g., means such as inputting a pre-registered PIN number into an affiliated store terminal and confirming whether or not it matches).

An automatic payment server according to an embodiment of the present disclosure includes an input unit which receives a user recognition information and a payment amount information, a memory in which the automatic payment program is stored, and a processor which performs the automatic payment program, wherein when user recognition information matched to the user identification information which has been made to become an ID by the algorithm is received, the processor performs an automatic payment approval process using a pre-registered payment method based on the payment amount information.

The user recognition information is any one of a user's face image and behavior pattern, or identification information (vehicle license plate number) of a vehicle which the user boards on. The payment amount information may include a payment amount determined according to a classification standard applied to each user using the user's personal information, or may include a payment amount for a product or service selected by the user. The automatic payment approval is performed using the payment method pre-registered by the user, and if there are a plurality of payment methods pre-registered by the user, the payment method that provides the maximum benefits, such as discount or accumulation, depending on the classification of the affiliated store where the user is recognized and wants to receive goods/services can be automatically selected, and the payment approval process can be performed.

A user's portable terminal according to an embodiment of the present disclosure includes an input unit which receives payment information according to a user recognition result, a memory in which the automatic payment program is stored, and a processor which performs the automatic payment program, wherein the processor performs user-centric payment using an automatic payment program. The user-centric payment method means that the customer receives payment approval directly from the financial institution by receiving the transaction amount from an franchiser of an affiliated store without transferring the customer's financial information to the affiliated store, so the user receives the approval from the financial institution after checking whether the affiliate store for which the user recognition has been performed is a reasonable affiliated store, and whether the transaction amount is accurate through the user's portable terminal, and the customer can be connected online with the service provider to receive benefits such as coupons and accumulations immediately on the site. The processor of the user's portable terminal may automatically transmit a payment approval request by using a payment method requesting the automatic payment for payment information received according to a user recognition result based on a user setting. Additionally, the processor of the user's portable terminal can select a payment method having the largest benefit information among a plurality of pre-registered payment methods, and automatically transmit a payment approval request using the selected payment method, considering the affiliated store information included in the payment information received according to the user recognition result, and the shared benefit information.

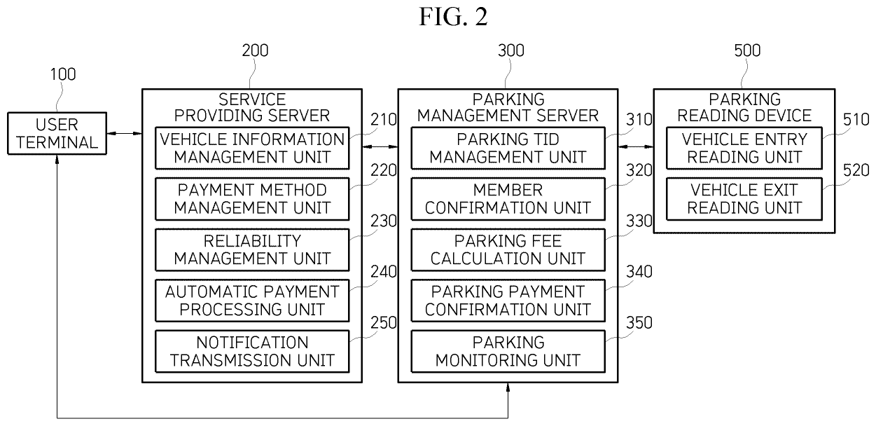

FIG. 2 shows an automatic parking fee payment system according to an embodiment of the present disclosure.

Regarding the payment of the parking fee, according to the basic scheme, the payment is made via a cashier or settlement machine at the exit of the parking lot while leaving the parking lot, or by using a pre-settlement machine before leaving the parking lot.

When paying to the cashier, since the payment method (card, cash, portable terminal) must be handed over and received, it is not possible to provide an untact service, which not only makes the payment process cumbersome but also raises concerns in terms of mutual hygiene management.

When the user gets on the vehicle and moves to the exit, and needs to perform the card payment process using the settlement machine (generally, the settlement machine dedicated to card payment is placed) in front of the exit crossing gate, the user must stop the vehicle considering the distance between the side of the vehicle and the settlement machine, and it's a real hassle to hold the credit card or mobile device in his/her hand, put his/her hand out of the car window, touch the credit card or mobile device to the preset area of the settlement machine to request the payment, and then take the credit card or mobile device back after completing the payment, and if the vehicle moves unintentionally because the brake pedal is not properly pressed due to negligence during the payment process, there is a risk of an accident such as collision against the crossing gate.

Comparing to the case of automatically opening the crossing gate by recognizing the vehicle license plate after the pre-settlement, the payment through a cashier or settlement machine in front of the crossing gate takes a longer time in front of the exit crossing gate, which often leads to the traffic congestion during the exit process, so the pre-settlement of the parking fee is encouraged through the words of guidance or announcement.

In the case of pre-settlement, the user must find the location of the settlement machine to pay the parking fee, and in order to prevent additional parking fees from occurring after the pre-settlement, the user must complete the vehicle exit within a certain time from the time of the pre-settlement (e.g., 15 minutes or 30 minutes from the time of the payment completion, according to the set conditions). So, when the user has to go to the bathroom after the payment, or when the user spends time on loading and organizing shopping items in the vehicle, or when the user have to talk on the phone for a long time due to a sudden phone call before the movement, or the like, there is a problem in that the user falls into a situation in which the user is psychologically under pressure to meet the time before which the user has to complete the vehicle exit. If an additional parking fee (parking fee generated by not completing the vehicle exit within a certain time from the time point of pre-settlement) is generated, it must be paid through a cashier or a payment machine in front of the exit crossing gate, so the above-mentioned inconvenience occurs as it is.

According to an embodiment of the present disclosure, a service providing server 200 includes a vehicle information management unit 210, a payment method management unit 220, an automatic payment processing unit 240, and a notification transmission unit 250.

A parking management server 300 includes a parking TID management unit 310, a member confirmation unit 320, a parking fee calculation unit 330, and an automatic payment confirmation unit 340.

A parking reading device 500 includes a vehicle entry reading unit 510 and a vehicle exit reading unit 520.

A user terminal 100 selects a vehicle registration in the application provided by the service providing server 200 and registers a vehicle information (vehicle number) and a vehicle owner name.

The vehicle information management unit 210 registers/manages the vehicle information and a vehicle owner name information.

The user terminal 100 transmits a payment method registration request for automatic payment, and at this time, transmits information on the payment limit for each transaction, the daily payment limit, and the monthly payment limit together.

The payment method management unit 220 registers/manages automatic payment method information, and upon initial registration, the automatic payment processing unit 240 confirms test payment approval and cancels the corresponding test payment.

Such test payment is not limited to the payment method registration, and may be made once again immediately before the vehicle exit. For example, when a parked vehicle moves to leave, a test payment using a corresponding registered payment method may be performed to check whether the parking fee will be paid normally, and the confirmation result may be notified to the user. Thus, when the automatic payment is not performed due to an excess of the limit or lack of balance for the corresponding payment method, a notification to change or newly register the automatic payment method may be provided.

The vehicle entry reading unit 510 recognizes the vehicle number to recognize the vehicle entry into the parking lot, and transmits the vehicle entry information to the parking management server 300.

The parking TID management unit 310 generates and registers a parking TID using a vehicle entry information including the vehicle number, and the vehicle entry photo information.

The member confirmation unit 320 transmits an automatic payment member confirmation request to the service providing server 200, and the service providing server 200 checks whether or not the user is the automatic payment member, and returns a response.

The user terminal 100 receives a notification push for the vehicle entry from the parking management server 300.

The notification transmission unit 250 is configured to provide, to the terminal of the owner of the vehicle entering, a notice that when the user subscribes to the application, the user can leave the parking lot immediately through the automatic payment of parking fees without the pre-settlement or the payment through a cashier.

The vehicle exit reading unit 520 recognizes the vehicle number to recognize the vehicle exit from the parking lot, and transmits the vehicle exit information to the parking management server 300.

The parking fee calculation unit 330 transmits the parking fee calculation result based on the corresponding vehicle exit information to the service providing server 200, and requests the payment.

The automatic payment processing unit 240 performs the automatic payment for the corresponding parking fee using the pre-registered payment method, and upon processing the automatic payment normally, the notification transmission unit 250 transmits the automatic payment result and the transaction approval details to the user terminal 100 and the parking management server 300.

When the automatic payment confirmation unit 340 confirms the completion of the automatic payment for the parking fee, it transmits an opening command to the exit crossing gate.

When the automatic payment for the parking fee does not proceed normally, the notification transmission unit 250 transmits an automatic payment failure push to the user terminal 100, and the user terminal 100 may perform the reset for the automatic payment. The service providing server 200 may transmit an unsettled vehicle exit permission request based on the reliability information calculated by the reliability management unit 230, and the service provider perform the may pre-settlement to affiliated store (the parking lot management side), and transfer the right to collect the unpaid payment from the affiliated store.

The service providing server 200 receives e-mail (public e-mail) information, payment institution information (account information, card information), biometric information (fingerprint, face ID), personal authentication ID information (e.g., Resident registration card, driver's license, student ID card, official ID card, or the like), and communication company information from the user terminal 100, and manages the reliability of a corresponding user through the reliability management unit. In order to increase user convenience through trust-based contracts, by providing services in the concept of a trust chain that combines trust and AI technology, it is possible to provide services that reduce costs and efforts and increase efficiency and connectivity through voluntary information sharing between trusted entities.

Regarding the user identification confirmation means, it is possible to manage individual reliability according to the number and classification (grade) of the registered identification confirmation means, and when the reliability exceeds the predetermined standard, it will be set to perform the above-mentioned pre-settlement process up to a certain amount.

In terms of reliability management, it is possible to manage reliability by using payment histories for each user (for example, whether there is no non-payment within a certain period of time in the payment processing when using the pre-settlement service, whether the details of pre-payment processing performed in advance before the payment date exceed a certain standard, or the like). The service providing server 200 according to an embodiment of the present disclosure performs a personal identification algorithm using the biometric information including at least one of the face image and the behavior pattern registered by the individual user, and associates the user ID information generated through this with the application, thereby allowing the automatic payment for the service use to be performed.

The parking monitoring unit 350 may monitor a parking situation in a parking lot where many vehicles are concentrated, for example, as in a supermarket, a shopping mall, and an amusement park parking lot, and may generate and transmit benefit information to the service providing server to support smooth vehicle exit.

For example, it is assumed that vehicle exits are concentrated in the parking lot of amusement park A from 16:30 to 17:30 on Sunday afternoon. The parking monitoring unit 350 may learn parking-related information using a deep learning technique, and store parking lot location information, density information, usage fee information, vehicle expected parking time information, and surrounding traffic situation information in a database to generate benefit information on a parking discount by using a result of learning through a neural network using learning data.

The parking monitoring unit 350 may check vehicle exit situation information and parking density information in real time, and generate benefit information about providing a parking fee discount of a certain percentage to the vehicles leaving the parking lot, for example, from 15:00 to 16:00, and after 18:00, and transmit a guidance message to the user terminal 100 through the service providing server 200.

This provides an effect to secure customer needs for revisiting by reducing the waiting time expected to be required for the vehicle exit according to the surrounding traffic conditions or the parking lot specifications despite the automatic payment.

Additionally, the parking monitoring unit 350 may provide to the user terminals 100 of the non-subscribers among the vehicles currently parked in the parking lot, who have not been confirmed through the member confirmation unit 320, through the service providing server 200 a notification that the benefit information (e.g., 50% reduction of the first parking fee after the automatic payment registration) may be provided when registering for the automatic payment.

The parking monitoring unit 350 can set and guide different vehicle exit times at which parking fee reduction benefits are provided to a plurality of vehicles in consideration of average parking time information, vehicle entry time information for each vehicle, surrounding traffic situation information, and parking density information.

For example, in a parking lot where the average parking time is 5 hours, for vehicles whose parking time is four or more hours after the vehicle entry, it can be set to provide benefits when leaving the parking lot within 30 minutes or after 1 hour and 30 minutes from the present time (when exiting the parking lot during a time period determined to prevent traffic congestion), and the benefits provided to other vehicles can be set differently by determining the extent to which the number of exiting vehicles increases according to the provision of benefits and the level to which the vehicle exit congestion would be resolved by the increasing amount of vehicle exits.

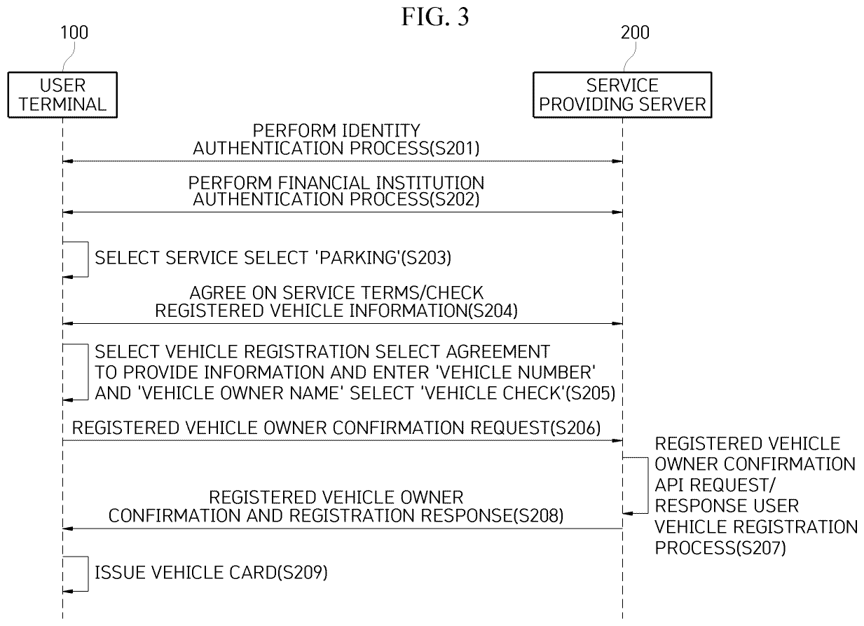

FIG. 3 shows a vehicle registration process according to an embodiment of the present disclosure.

In the user terminal 100, an application provided by a service provider is downloaded and installed, and a user authentication process is performed through the application (S201), and a financial institution authentication process is performed (S202).

According to an embodiment of the present disclosure, it is possible to receive biometric information including at least one of a user's face image and other behavior patterns, make the biometric information to become an ID via a personal identification algorithm to generate user ID information, and create a database of the biometric information so that the automatic payment according to service use is performed by connecting user ID information to the application.

The user terminal 100 selects a “parking” service menu after executing the application (S203).

The user terminal 100 inputs service terms agreement information on the terms agreement page, and selects ‘Confirm’. At this time, in the case of a user account that has agreed to the terms, it immediately moves to the service page after skipping the procedure for agreeing to the terms. When a vehicle registration guidance pop-up occurs in the application, ‘Confirm’ is selected, and if ‘Register later’ is selected, non-exposure until the preset date (e.g., the next day) is set and it moves to the service page. ‘Vehicle Registration’ on the ‘My Information’ screen in the application is selected, and it moves to the vehicle registration page, and the registered vehicle information is checked (S204). After agreeing to provide information, the vehicle number and the owner are inputted, and ‘Vehicle confirmation’ is selected. If it is confirmed that it is a rental car as a result of vehicle number identification, the ‘owner’ item is automatically changed to the name of ‘rental car’, and the company name is entered (S205). When ‘Add vehicle’ is selected, the same input format is displayed at the bottom of the information input screen, and the vehicle number and the owner information are entered.

The user terminal 100 transmits a registered vehicle owner confirmation request to the service providing server 200 (S206), and the service providing server 200 performs a registered vehicle owner confirmation API request response, and processes user vehicle registration (S207).

The service providing server 200 transmits the registered vehicle owner confirmation and registration response to the user terminal 100 (S208), and the user terminal 100 issues a vehicle card (S209). After the registration completion guidance pop-up appears, selecting the ‘Confirm’ button results in the movement to the ‘My Car’ service page.

The vehicle information can be inquired through the expressway toll server, or the vehicle owner verification API is used through the MyData project.

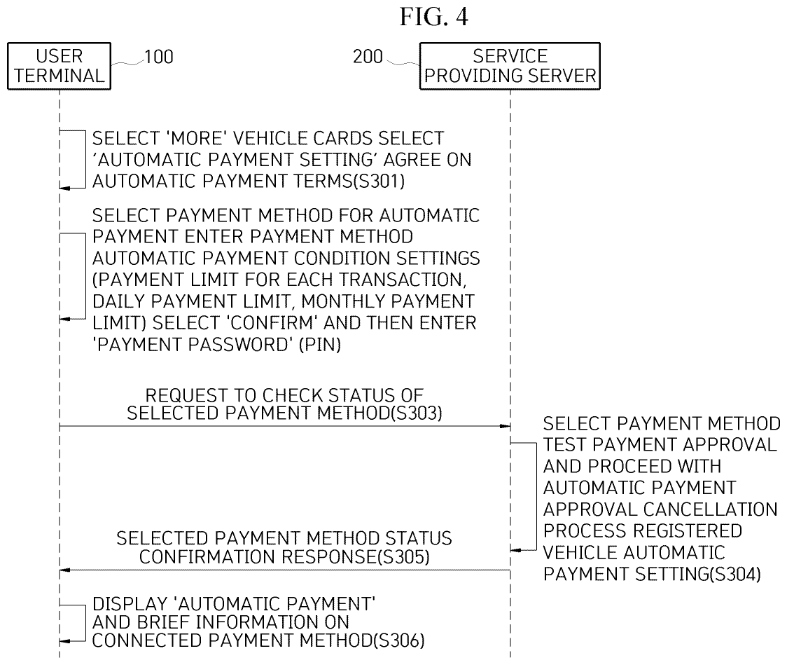

FIG. 4 shows an automatic payment setting process according to an embodiment of the present disclosure.

After executing the application, the user terminal 100 selects the ‘parking’ menu, moves to the service main screen, selects the ‘More’ menu of the registered vehicle card, and selects ‘Automatic payment settings’. Next, agreement information is entered into the automatic payment terms (S301).

When a payment method is selected from the payment method selection list, automatic payment conditions are set. The amounts for ‘Payment amount limit for each transaction’, ‘Daily payment amount limit’, and ‘Monthly payment amount limit’ are entered. After the entering, when selecting ‘Confirm’, an automatic payment setting guidance pop-up is displayed, and the payment password is entered (S302). The service providing server 200 receives a confirmation request for the selected payment method from the user terminal 100 (S303), proceeds with a partial payment request, and moves to the automatic payment setting completion screen when the payment is approved, and cancels the approval for the corresponding payment immediately after the payment approval (S304). The service providing server 200 transmits the selected payment method status confirmation response to the user terminal 100 (S305).

The user terminal 100 moves to the ‘parking’ service page to check the automatic payment registration setting after confirming the completion of the automatic payment setting, and displays the ‘automatic payment’ status information and brief information about the payment method card/account on the vehicle card (S306).

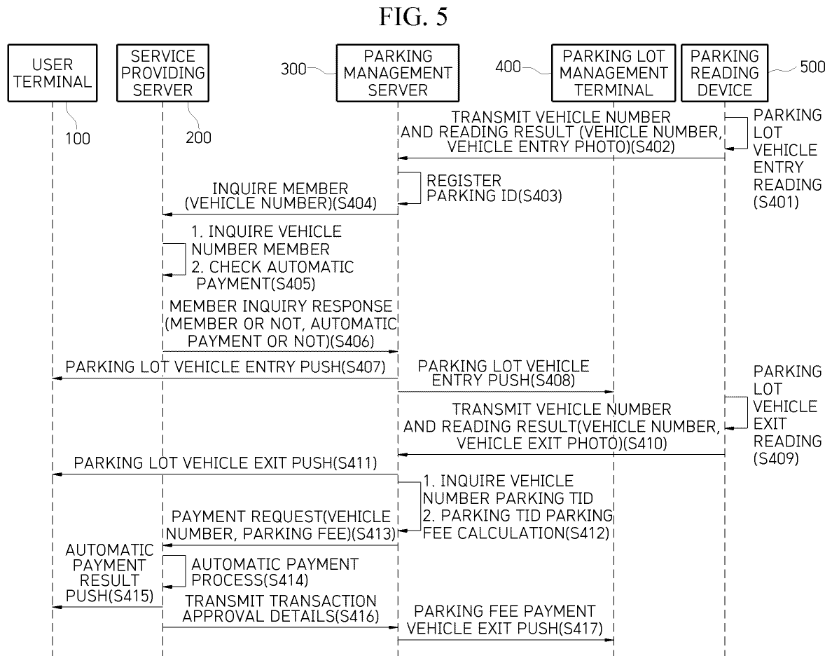

FIG. 5 shows an automatic parking fee payment process according to an embodiment of the present disclosure.

The application provided by the service provider is installed in the user terminal 100, and the user registers a user authentication and payment institution, and registers information on one or more vehicles in the application. It is assumed that a parking lot management application is downloaded and installed in the parking lot management terminal 400, an affiliated parking lot is registered as an affiliated store, and a parking fee system is set.

When entering a parking lot affiliated with the automatic parking fee payment service, the parking reading device 500 proceeds to check the vehicle entry with a camera and AI parking reading (S401).

The parking reading device 500 transmits the vehicle number and the reading result (vehicle number, vehicle entry photo) to the parking management server (S402). At this time, the parking lot name, parking start time, fee classification (general rate, use ticket, season ticket, or the like), payment method (normal payment, automatic payment), and parking location information are transmitted.

The parking management server 300 registers the parking TID (S403), transmits a user confirmation request to the service providing server 200, and requests member inquiry using the vehicle number (S404).

The service providing server 200 performs the member inquiry using the vehicle number, and checks whether or not the automatic payment has been selected (S405).

When a member inquiry response is transmitted to the parking management server 300 according to member confirmation (S406), the parking management server 300 notifies the user terminal 100 and the parking lot management terminal 400 of the vehicle entry into the parking lot through a push (S407, S408).

If it is determined that the user's vehicle is about to depart from the parking lot, the parking lot vehicle exit reading is performed through the AI parking reading (S409).

The parking reading device 500 transmits the vehicle number and the reading result (vehicle number, vehicle exit photo) to the parking management server 300 (S410), and at this time, the parking lot name, the parking usage time (start-end), the fare classification (normal rate, pass, season ticket, or the like), the payment method (normal payment, automatic payment), the payment status, the parking photo, and the parking location are transmitted.

The parking management server 300 transmits the parking lot vehicle exit push to the user terminal 100 (S411), inquires the vehicle number and the parking TID, and calculates a parking fee matched to the parking TID (S412).

The parking management server 300 transmits the vehicle number and the parking fee information to the service providing server 200, and requests the payment (S413), and the service providing server 200 performs the automatic payment process using the pre-registered payment method (S414).

At this time, when there are a plurality of pre-registered payment methods, the automatic payment process is performed in consideration of benefit information (e.g., parking lot partnership credit card information, or the like).

The service providing server 200 transmits the automatic payment result push to the user terminal 100 when the automatic payment has been completed (S415), and transmits the transaction approval details to the parking management server 300 (S416).

The parking management server 300 transmits a push for the parking fee payment and the vehicle exit to the parking lot management terminal 400 (S417).

According to another embodiment of the present disclosure, as described above, it is possible to determine whether a user ID associated with a user app matches based on the user's face recognition information or input information of a preset behavior pattern, confirm that the user has expressed an intention to pay for the provided service based on the determination result, and control the automatic payment using a pre-registered payment method.

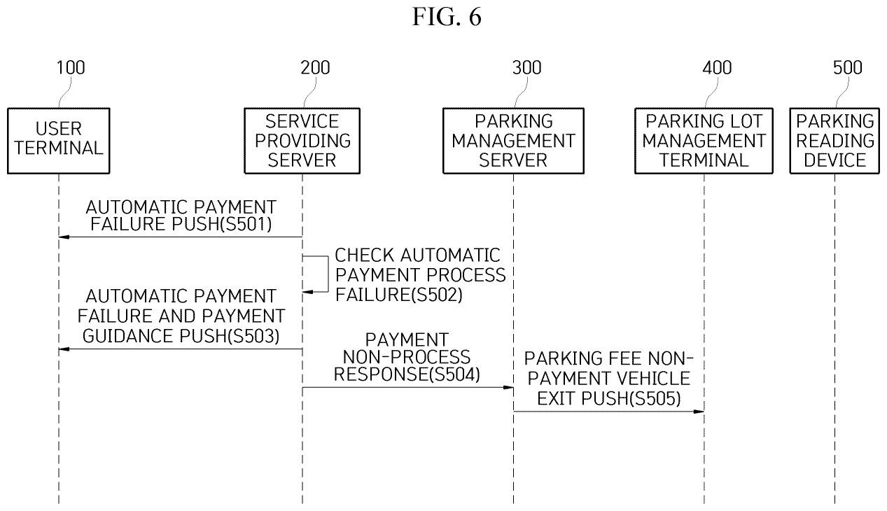

FIG. 6 shows a progress process when the automatic parking fee payment fails, according to an embodiment of the present disclosure.

The process proceeds in the same way up to steps S401 to S413 described above with reference to FIG. 5.

If the automatic payment fails, the service providing server 200 informs the user of the automatic payment failure push (S501), and confirms the automatic payment process failure (S502).

When receiving the automatic payment failure and payment guidance push (S503), and receiving guidance on automatic payment re-payment and occurrence of disadvantages (information on occurrence of disadvantages under the Civil and Criminal Acts), the user terminal 100 proceeds with the automatic payment setting, and the service providing server 200 transmits a non-process payment response to the parking management server 300 (S504).

The parking management server 300 transmits, to the parking lot management terminal 400, a vehicle exit push for a vehicle whose parking fee has not been paid (S505).

If there is an unpaid case for automatic parking fee payment, a pop-up is exposed in the application installed on the user terminal 100, notifying that civil and criminal penalties may be incurred, and, when: moving to the ‘Notification’ screen, allowing a guidance to be provided for proceeding with the payment of parking fee, and, when automatic payment is set, allowing the automatic payment to be made for the unpaid parking fee.

For the unpaid parking fee, additional payment may be charged to the user according to the time period during which the payment has not been made, and as the service provider may pre-settle it to the affiliated store, and transfer the right to collect the unpaid parking fee from the affiliated store, it is possible to prevent risky transactions from occurring in the affiliated store.

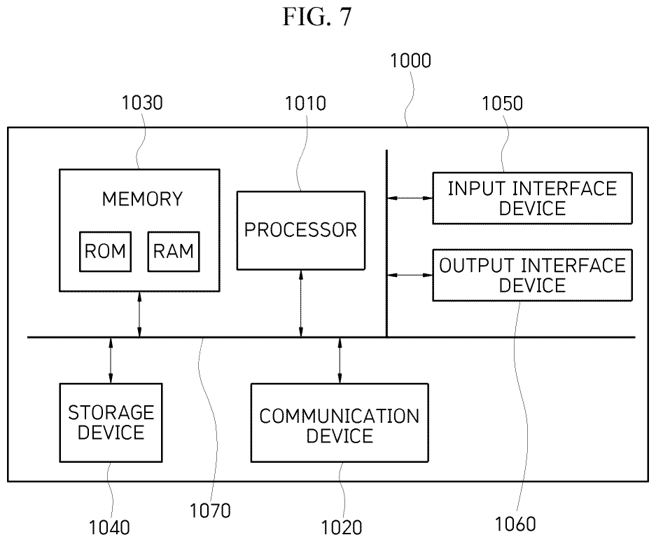

FIG. 7 is a block diagram representing a computer system for implementing a method according to an embodiment of the present disclosure.

Referring to FIG. 7, a computer system 1000 may include at least one of a processor 1010, a memory 1030, an input interface device 1050, an output interface device 1060, and a storage device 1040 which communicate to each other through a bus 1070. The computer system 1000 may also include a communication device 1020 coupled to a network. The processor 1010 may be a central processing unit (CPU) or a semiconductor device that executes instructions stored in the memory 1030 or the storage device 1040. The memory 1030 and the storage device 1040 may include various types of volatile or non-volatile storage media. For example, the memory may include a read only memory (ROM) and a random access memory (RAM). In an embodiment of the present disclosure, the memory may be located inside or outside the processor, and the memory may be connected to the processor through various known means. The memories may be volatile or non-volatile storage media in various forms, and may include, for example, read-only memories (ROM) or random access memories (RAM).

Accordingly, an embodiment of the present disclosure may be implemented as a computer-implemented method, or as a non-transitory computer-readable medium in which computer-executable instructions are stored. In one embodiment, when executed by a processor, the computer readable instructions may perform a method according to at least one aspect of the present disclosure.

The communication device 1020 may transmit or receive a wired signal or a wireless signal.

Additionally, the method according to the embodiment of the present disclosure may be implemented in the form of program instructions that can be executed through various computer means, and thus may be recorded on a computer readable medium.

The computer readable medium may include program instructions, data files, data structures, or the like alone or in combination with each other. The program instructions recorded on the computer readable medium may be specially designed and configured for the embodiments of the present disclosure, or may be known to and usable by those skilled in the art in the field of computer software. The computer-readable recording medium may include a hardware device configured to store and execute program instructions. For example, the computer-readable recording media may be magnetic media such as hard disks, floppy disks and magnetic tapes, optical media such as CD-ROMs and DVDs, magneto-optical media such as floptical disks, ROMs, RAMs, flash memories, or the like. The program instructions may include high-level language codes that can be executed by a computer through an interpreter or the like as well as machine language codes generated by a compiler.

While the embodiments of the present disclosure have been described in detail above, the scope of the patent right of the present disclosure is not limited thereto, but various modifications and improvements which could be made by those skilled in the art using the basic concept of the present disclosure defined in the following claims would also fall within the scope of the patent right of the present disclosure.

What is claimed is:

1. An automatic payment method comprising:
(a) performing a user application connection process while registering user information;
(b) generating payment information while recognizing a user; and
(c) performing user application connection and automatic payment approval.

2. The automatic payment method of claim 1, wherein the step (a) is registering the user information including user ID information generated by applying a personal identification algorithm to biometric information.

3. The automatic payment method of claim 2, wherein the step (a) is automatically generating and registering an additional image in consideration of at least one of whether an accessory is worn or not and a photographing angle, when face image information is included in the biometric information.

4. The automatic payment method of claim 1, wherein the step (b) is generating the payment information for grouped users, and the step (c) is performing the automatic payment approval using the payment method of at least one of the grouped users.

5. The automatic payment method of claim 1, wherein the step (b) is generating the payment information for a payment amount set for each user classification and determining the payment information in consideration of a user's basic information, or generating a payment target amount for goods or services selected by the user as the payment information.

6. An automatic payment server comprising:
an input unit which receives a user recognition information and a payment amount information;
a memory in which an automatic payment program is stored; and
a processor which performs the automatic payment program,
wherein when a user recognition information matched to a user identification information identified by an algorithm is received, the processor performs an automatic payment approval process using a pre-registered payment method based on a payment amount information.

7. The automatic payment sever of claim 6, wherein when the processor uses one of a plurality of payment methods pre-registered by a user, the processor automatically selects a payment method in consideration of user benefits including discounts or accumulations according to classification of affiliated stores, and performs payment approval process.

8. A user's portable terminal device using automatic payment service, the user's portable terminal device comprising:
an input unit which receives payment information according to a user recognition result;
a memory in which an automatic payment program is stored; and
a processor which performs the automatic payment program,
wherein the processor transmits an approval request for the payment information to a financial institution to perform a user-centric payment.

9. The user's portable terminal device of claim 8, wherein the processor transmits an approval request for the payment information when receiving confirmation input for an affiliated store information and a transaction amount information for which user recognition has been performed.

10. The user's portable terminal device of claim 8, wherein the processor selects a payment method matched to the corresponding payment from among a plurality of pre-registered payment methods, in consideration of an affiliated store information included in a payment information received according to the user recognition result and a shared benefit information, and automatically transmits the approval request using the selected payment method.
